(19) United States
(12) Patent Application Publication
(10) Pub. No.: US 2011/0025816 A1
(43) Pub. Date: Feb. 3, 2011

(54) ADVERTISING AS A REAL-TIME VIDEO CALL

(75) Inventors: Brett D. Brewer, Sammamish, WA (US); Melissa W. Dunn, Woodinville, WA (US); Milind V. Mahajan, Redmond, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/533,139

(22) Filed: Jul. 31, 2009

(51) Int. Cl. H04N 7/14; G06Q 30/00

(52) U.S. Cl. 348/14.02; 705/14.4; 348/E07.077

(57) ABSTRACT

The claimed subject matter provides systems and/or methods that effectuate distribution of advertising as real-time video calls. The system can include devices that detect whether or not a mobile device associated with a user is in the vicinity of a retail establishment, ascertains whether or not the proximate mobile device is receptive to receipt of advertising from the retail establishment, negotiates with the mobile device to determine at least one user preference with respect to a real-time video call, and based on the ascertained user preferences, downloads the appropriate real-time video call to the mobile device and/or establishes a live audio-visual connection with a representative of the retail establishment, wherein during the live audio-visual connection negotiations between the user and the representative is effectuated and the user comprehends that they are communicating with a famous personality.

### BACKGROUND

Microprocessor-based devices have evolved into reliable and pervasive tools that facilitate everyday common tasks (e.g., microwave cooking, automobile ignition systems, entertainment centers, . . . ), complex mathematical computations (e.g. trending, controlling a robot, forecasting, and the like), sophisticated applications (e.g. business workflow, word processing, financial logging, electronic mail, etc.), and the like. Such devices typically include one or more processors and various types of memory as well as other components that enable efficient and robust multitasking. Incremental advances in electronics, networking, and software technologies have resulted in reduced device production costs that have correlated to decreased consumer purchasing costs, which have rendered computers (e.g., desktop, laptop, hand-held, . . . ) essentially ubiquitous throughout many portions of the world.

As computing devices have become more widespread, migration to various other fields such advertising have been rising. Currently, computers are being utilized for web-based advertising that rely almost exclusively on a click through advertising paradigm in which fixed spatial scale images are employed to encourage a potential customer to click the advertisement, whereby the potential customer can then be routed via hyperlink to more extensive information pertaining to the advertisement. Furthermore, such web-based advertisements are typically pre-identified and placed in predetermined locations on websites, webpages, webspaces, and the like based at least in part on potential traffic (e.g., placing a sports related advertisement on a sports team webpage, etc.). Nevertheless, such advertising placement can only be considered wasteful of resources in that such blanket coverage invariably and woefully misses its target demographic.

The subject matter as claimed is directed toward resolving or at the very least mitigating, one or all the problems elucidated above.

### SUMMARY

The following presents a simplified summary in order to provide a basic understanding of some aspects of the disclosed subject matter. This summary is not an extensive overview, and it is not intended to identify key/critical elements or to delineate the scope thereof Its sole purpose is to present some concepts in a simplified form as a prelude to the more detailed description that is presented later.

The claimed subject matter in accordance with various aspects set forth herein provides a new paradigm in interactive advertisements. In particular, the claimed matter provides advertising content to mobile devices that can have webcam capabilities. Hence, advertising content can, for example, be live and from a real personality (e.g., a live person) who provides a brief sales pitch or the like in a face-to-face manner. Furthermore, since the advertisement is live, interactive, and one-on-one, negotiations can take place as well. The advertisement can be based on a received call as well as a dialed call and can be activated at certain times in preference to others. For example, the advertisement can be delivered when it is determined or inferred that a mobile device user is not busy, or when the mobile device (or user) is proximal to a point of sale of the advertiser.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a machine-implemented system that effectuates and/or facilitates advertising as a real-time video call in accordance with an aspect of the claimed subject matter.

FIG. 2 provides further depiction of a mobile device that effectuates and/or facilitates advertising as a real-time video call in accordance with an aspect of the claimed subject matter.

FIG. 3 provides further illustration of a retail establishment component that effectuates and/or facilitates advertising as a real-time video call in accordance with an aspect of the claimed subject matter.

FIG. 4 illustrates a machine implemented method that effectuates and/or facilitates advertising as a real-time video call in accordance with an aspect of the claimed subject matter

FIG. 5 depicts a machine implemented method that effectuates and/or facilitates advertising as a real-time video call in accordance with an aspect of the claimed subject matter

FIG. 6 illustrates a flow diagram of a machine implemented methodology that effectuates and/or facilitates advertising as a real-time video call in accordance with an aspect of the claimed subject matter.

FIG. 7 illustrates a block diagram of a computer operable to execute the disclosed system in accordance with an aspect of the claimed subject matter.

FIG. 8 illustrates a schematic block diagram of an illustrative computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

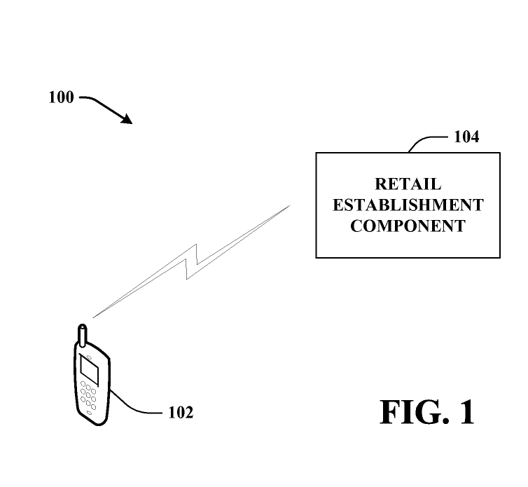

FIG. 1 illustrates a system 100 that effectuates and/or facilitates advertising as a real-time video call. As depicted, system 100 can include mobile device 102 that can be communicatively coupled to a retail establishment component 104. Since the basic premise of the claimed subject matter is that users of mobile devices, such as mobile device 102, can as they pass by points of sale or retail establishments receive directed advertising content (e.g., audio and/or video) in regard items that they can have a desire for or can have previously elicited a need for, the advertising content can be dispatched by retail establishment component 104 on an as needed basis. It will thus be appreciated by those moderately cognizant in this field of endeavor that while mobile device 102 and retail establishment component 104 can be communicatively coupled for the purposes of data interchange (e.g., for retail establishment component 104 to disseminate an appropriate and directed advertisement to mobile device 102) the coupling in this case, without limitation or loss of generality, is envisioned to be momentary rather than permanent (or semi-permanent).

Mobile device 102 can be implemented entirely in hardware and/or a combination of hardware and/or software in execution. Further, mobile device 102 can be incorporated within and/or associated with other compatible components. Additionally, mobile device 102 can be, but is not limited to, any type of machine that includes a processor and/or is capable of effective communication with a network topology and/or cloud. Illustrative machines that can comprise mobile device 102 can include desktop computers, cell phones, smart phones, laptop computers, notebook computers, Tablet PCs, portable or mobile consumer and/or industrial devices and/or appliances, hand-held devices, personal digital assistants, multimedia Internet mobile phones, multimedia players, and the like.

As stated above mobile device 102 can be in continuous and/or operative or sporadic and/or intermittent communication with retail establishment component 104 via a network topology and/or cloud. Such a network topology and/or cloud can include any viable communication and/or broadcast technology, for example, wired and/or wireless modalities and/or technologies can be utilized to effectuate the claimed subject matter. Moreover, the network topology and/or cloud can include utilization of Personal Area Networks (PANs), Local Area Networks (LANs), Campus Area Networks (CANs), Metropolitan Area Networks (MANs), extranets, intranets, the Internet, Wide Area Networks (WANs)—both centralized and/or distributed—and/or any combination, permutation, and/or aggregation thereof. Additionally, the network topology and/or cloud can include or encompass communications or interchange utilizing Near-Field Communications (NFC) and/or communications utilizing electrical conductance through the human skin, for example.

Retail establishment component 104 can be a machine associated with a retail establishment or point of sale such as a grocery store, fashion clothing outlet, consumer electronics outlet, automotive dealership, vending machine, etc. Retail establishment component 104 can be implemented entirely in hardware and/or as a combination of hardware and/or software in execution. Further, retail establishment component 104 can be, but is not limited to, any type of engine, machine, instrument of conversion, or mode of production that includes a processor and/or is capable of effective and/or operative communications with a network topology and/or cloud. Illustrative instruments of conversion, modes of production, engines, mechanisms, devices, and/or machinery that can comprise and/or embody retail establishment component 104 can include desktop computers, server class computing devices and/or databases, cell phones, smart phones, laptop computers, notebook computers, Tablet PCs, consumer and/or industrial devices and/or appliances and/or processes, hand-held devices, personal digital assistants, multimedia Internet enabled mobile phones, multimedia players, and the like.

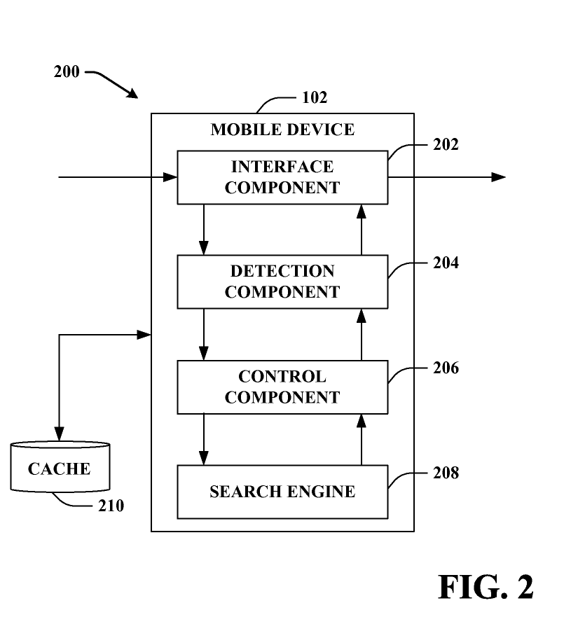

FIG. 2 provides further depiction of mobile device 102 in accordance with an aspect of the claimed subject matter. As illustrated, mobile device 102 can include interface component 202 (hereinafter referred to as “interface 202”) that can receive input in the form of directed and/or customized advertising content (e.g., audio and/or video) from a retail establishment component 104, and thereafter can direct such input to a display (or audio) device (not shown) or persist the incoming content to cache 210, for subsequent play back, for example. Interface 202 can provide various adapters, connectors, channels, communication pathways and/or modalities, etc. to integrate mobile device 102 into virtually any operating and/or database system(s) and/or with one another. Additionally, interface component 202 can provide various adapters, connectors, channels, communication pathways and/or methodologies, etc. to effectuate and facilitate interaction with and between mobile device 102, retail establishment component 104, and/or any other component, data and the like associated with system 100.

Additionally, mobile device 102 can include detection component 204 that can utilize various lists that the user can have created that contain retailers, fashion houses, fashion labels, designers, and/or products of interest to the user. Thus, utilization of such a list by detection component 204 can ensure that as the user moves about past various points of sale or retail establishments that he/she is not bombarded or spammed with unsolicited and unwanted content. In this manner the user of mobile device 102 through utilization of detection component 204 can have some semblance of control over the content that he/she receives, since it is through utilization of detection component 204 that mobile device 102 can indicate to the various retail establishments or points of sale the user's willingness to receive appropriate content (e.g., content that the user elicits a desire for or needs). Moreover, in accordance with an aspect of the claimed subject matter, and in concert with the various lists persisted, for example in cache 210, a retail establishment component 104, rather than dispatching video and/or audio content to be viewed, or listened to, by the user either contemporaneously on receipt, or at a future time or date, can direct a text message to the mobile device indicating a call back number that the user can call when and if he/she should desire. With this call back number the user can receive audio and/or video content from the retail establishment or point of sale that can be customized (or made to appear as if it is directed) specifically to the user regarding items of interest to the user. Nevertheless, it should be noted without limitation or loss of generality that since mobile device 102 will typically be carried on the person of the user, there can be occasion where by the time retail establishment component 104 has recognized that mobile device 102 can be a candidate in advertising that mobile device 102 (and therefore the user) is no longer proximate to retail establishment component 104, has become otherwise engaged, or is being utilized for some other purpose (e.g., receiving or placing a telephone call, etc.). In such circumstances retail establishment component 104 can automatically and/or dynamically undertake to perform the most appropriate course of action. For instance, where the user is utilizing the voice capabilities of mobile device 102 while nonetheless being in the vicinity of retail establishment component 104, retail establishment component 104 can direct a text message to mobile device 102 indicating a call back number that the user can call when and if he/she should desire. Additionally and/or alternatively, where the user (and hence mobile device 102) is beyond the broadcasting extent of retail establishment component 104 and the user is not utilizing mobile device 102 for any purpose, retail establishment component 104 can adopt any mechanism necessary to disseminate appropriate advertising content to mobile device 102 (e.g., text messaging hyperlinks to personalized advertising, directing audio/visual advertising content to the user via email, and the like).

To put the foregoing in slightly more context, consider the following example, where a user elicits a preference for a particular personality (e.g., Massimo Muscles the mixed martial arts fighter or Traci Svelte the fashion designer). As the user passes by a retail establishment or point of sale that sells items of interest endorsed by Massimo Muscles or that sells garments designed by Traci Svelte, detection component 204, in conjunction with various and sundry lists that can have been previously persisted or collaboratively developed (e.g., though utilization of various collaborative filtering mechanisms), can provide indication to a retail establishment or point of sale (e.g., retail establishment component 104) of the users interests. The retail establishment component 104 on receipt of such indication can direct to mobile device 102 video or audio content that the user can listen to or view. Typically, the video or audio content can be put forth in such a way (e.g., first person narrative) as to convey to the listener or viewer that Massimo Muscles or Traci Svelte is personally communicating with the user and encouraging the user to visit the retail establishment and purchase the items of interest contained in the list. Additionally and/or alternatively, retail establishment component 104 on receipt of indications as to the user's preferences, rather than directing video or audio content, can send to mobile device 102 a call back telephone number so that the user can use the call back number to receive a personalized message from Massimo Muscles or Traci Svelte as the case may indicate. In both of the foregoing instances, the personality (e.g., Massimo Muscles or Traci Svelte) can provide advertising content related to the items that the user is interested in and that are available in the retail establishment. It should be appreciated, without limitation or loss or generality, that voice synthesis and other masking technologies (e.g., utilizing animated video overlay technologies) can be employed by retail establishment component 104, wherein sale personnel associated or affiliated with the retail establishment or point of sale can converse or directly communicate in real-time or contemporaneously (e.g., live) with the user in the guise of the famous personality or utilizing the mien of the famous personality.

Additionally, mobile device 102 can include control component 206 that can provide the user a mechanism to prevent retailers from indiscriminately directing advertising to mobile phone 102 despite the fact that the retailer may be selling or have available items of interest to the user. To provide the user with such a degree of control, control component 206 can include an on/off switch that the user can engage where he/she does not want to be disturbed with any advertising material at all. Additionally and/or alternatively, control component 206 can utilize various and sundry lists that can have been previously been persisted or collaboratively developed to distinguish between retailers and items that the user deems desirous or of interest.

It should be noted without limitation or loss of generality that advertising content that is to be directed at specific users must be appealing to the targeted user (e.g., the advertisement should be useful, entertaining and/or engaging) otherwise the user will in all probability find the content valueless or pointless. Accordingly, any content that is to be directed to mobile device 102 by retail establishment component 104 needs to be personalized or individuated to each and every user. So for instance, if a user elicits a preference of clothes designed by Traci Svelte a personalized message (or video) from Traci Svelte to the user can be directed to mobile device 102. More particularly, the personalized message should come across as if the personality (e.g., Traci Svelte) is personally communicating with the user and that the message put forth is not a generic message directed at the general public at large.

Further, mobile device 102 can include search engine 208 that the user can utilize to facilitate or effectuate searches for items that he/she wishes to purchase or would like to investigate further. As will be appreciated by those cognizant in this field of endeavor, utilization of search engine 208 will over time develop a relatively comprehensive outline of items that the user might be interested in and the user's likes and aversions. For example, the user can in the recent past have initiated on search engine 208 a search for mattresses, so this information (e.g., size of mattress, type of bed springs, quality of mattress, etc.) can be utilized to develop a profile of the mattresses that might satisfy the user's needs. Thus, based at least in part on these search criteria, detection component 204 can disseminate to retail establishment component 104 indication that the user is in the market for mattresses with certain characteristics, and that if, and only if, the retail establishment has mattresses that satisfy these criteria, should retail establishment component 104 respond by directing content to mobile device 102 for user to contemporaneously or subsequently listen to or view. Moreover, in connection with search engine 204, it is to be understood that search engine 204 can gather and collate search criteria from any and all devices that the user might possibly utilize to effectuate searches. For instance, the user, rather than utilizing the search facility associated with mobile device 102, could have utilized a desktop PC search engine to actuate the search of mattresses. In this case mobile device 102 can synchronize (e.g., through wired and/or wireless methodologies) with the desktop PC to collect the search criteria in order to develop (or further develop) the necessary profile.

Mobile device 102 can also include cache 210 that can include any suitable data necessary for mobile device 102, and in particular detection component 204, control component 206, and search engine 208 to facilitate its aims. For instance, cache 210 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate networks, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information obtained from the disparate network, ratings from a website, a credit score, geographical location, a donation to charity, or any other information related to software, applications, web conferencing, and/or any suitable data related to transactions, etc.

It is to be appreciated that cache 210 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink® DRAM (SLDRAM), Rambus® direct RAM (RDRAM), direct Rambus® dynamic RAM (DRDRAM) and Rambus® dynamic RAM (RDRAM). Cache 210 of the subject systems and methods is intended to comprise, without being limited to, these and any other suitable types of memory. In addition, it is to be appreciated that cache 210 can be a server, a database, a hard drive, and the like.

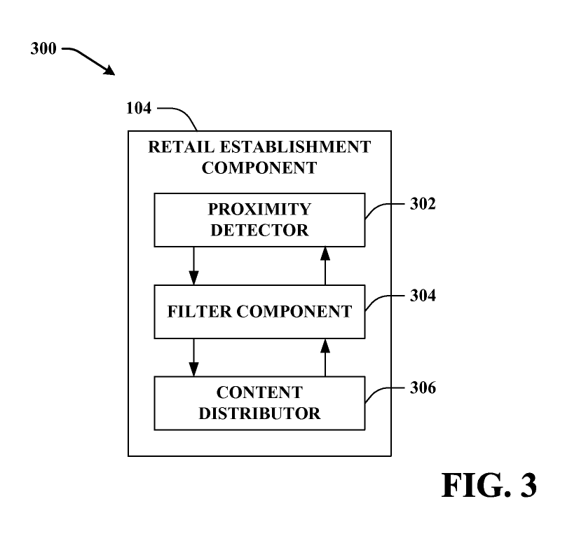

FIG. 3 provides further depiction of retail establishment component 104 in accordance with aspects of the claimed subject matter. As stated earlier, retail establishment component 104 can be implemented entirely in hardware and/or a combination of hardware and/or software in execution. Further, retail establishment component 104 can be incorporated within and/or associated with other compatible components. Additionally, retail establishment component 104 can be, but is not limited to, any type of machine that includes a processor and/or is capable of effective communication with a network topology and/or cloud. Illustrative machines that can comprise retail establishment component 104 can include desktop computers, server class computing devices, cell phones, smart phones, laptop computers, notebook computers, Tablet PCs, consumer and/or industrial devices and/or appliances, hand-held devices, personal digital assistants, multimedia Internet mobile phones, multimedia players, and the like. Further, it is to be appreciated that retail establishment component 104 can include or be associated with a storage aspect that can be similar in functionality and facility to that elucidated with respect to cache 210, above, wherein such a storage aspect can persist various advertising content, such as first person narratives from Massimo Muscles or Traci Svelte outlining the virtues of various items that are being provisioned within the retail establishment or by the point of sale and the benefits that a user can be afforded if they decide to purchase items from the retail establishment or point of sale.

As illustrated retail establishment component 104 can include proximity detector 302 that can detect whether or not mobile device 102 is receptive to receipt of advertising content directed from the retail establishment or point of sale. Mobile device 102 can indicate its willingness (or more particularly the user's willingness) to receive audio or visual blandishments (e.g., advertising content) based at least in part on lists persisted, developed and/or associated with mobile device 102. For example, the user can have, during set up (or sometime thereafter) of mobile device 102, provided lists of retailers that he/she visits regularly, those that he/she visits occasionally, and retailers that he/she never visits and never intends visiting (e.g., the retailers that are never visited can be perceived by the user as being too expensive or the user has found the customer service at these retailers have not met his/her expectations). Additionally, the user may also have provided initial indications as to his/her likes and dislikes, from which inferences (e.g., though utilization of inference engines and/or machine learning associated with mobile device 102) can be drawn and a predictive profile constructed and over time refined. Furthermore, the user can also have provided indication (or these aspects can be deduced utilizing machine learning and/or artificial intelligence) of famous personalities that he/she admires and wishes to associate with (e.g., this aspect can be deduced by investigating the user's tastes in music, movies, video games, sports, and the like). Thus, while proximity detector 302 associated with retail establishment component 104 can detect the presence of all mobile devices within its environs; the determination of whether or not content should be directed to mobile device 102 can be controlled by the mobile device. Where the mobile device provides suggestion that the user wishes or is interested in receiving advertising content (e.g., in the form of a video or audio clip) from a particular retail establishment or point of sale, with regard to a particular item of interest, or in the guise of a particular famous personality, then retail establishment component 104 through proximity detector 302 can initiate data interchange with mobile device 102 in order to send appropriate advertising content to mobile device 102.

Retail establishment component 104 can further include filter component 304 that can utilize information obtained during data interchange with mobile device 102 wherein such information can include user preferences that can have been solicited from the user or deduced or inferred from previous interactions between the user and the retail establishment (e.g., the user can be a regular customer of the retail establishment in that he/she carries a store credit card or rewards card) from which retail establishment component 104, through data mining, machine learning and/or artificial intelligence functionalities and facilities associated with retail establishment component 104, can draw inferences and/or deductions regarding the users respective likes and/or dislikes. Additionally and/or alternatively, from previous and/or concurrent intercommunication between mobile device 102 and retail establishment component 104, filter component 304 can utilize such information to determine what content should be directed to the user (e.g., text message, audio message, video message, size of the message, which personality to associated with the content, . . . ), whether the content is appropriate given the user's established and dynamically changing profile of likes and/or dislikes, how the content should best be delivered to the user, where the content should be delivered (e.g., to mobile device 102 or to the user's home PC, etc.), and/or when the content should be delivered (e.g., immediately, in a hour's time, this evening, etc.). As will be appreciated by those moderately conversant in this field of endeavor the functionality and facilities utilized by filter component 304 in order to achieve the foregoing can be undertaken for the most part by machine learning, artificial intelligence, and/or collaborative filtering techniques and mechanisms. Moreover, as will be apparent to those of ordinary skill, various aspects of filter component 304 can employ technologies associated with facilitating unconstrained optimization and/or minimization of error costs. Thus, non-linear training systems and/or methodologies (e.g., back propagation, Bayesian, fuzzy sets, non-linear regression, and/or other neural networking paradigms including mixture of experts, cerebella model arithmetic computer (CMACS), radial basis functions, directed search networks and function link networks can be employed by filter component 304.

Furthermore, retail establishment component 104 can include content distributor 306 that can utilize the inputs received from, and/or deduced by, filter component 304 to select appropriate content (e.g., text, audio, video, etc.) to disseminate to mobile device 102. As stated above with regard to filter component 304, content dispatched by content distributor 306 can be based at least in part on determinations regarding what content should be directed to the user, whether the content is appropriate given the user's established and dynamically evolving profile, how the content should best be delivered to the user (e.g., this can be a factor of mobile device 102 capabilities), where the content should be delivered, and/or the chronogrammatic period in which content should be delivered.

Additionally and/or alternatively, content distributor 306, based at least in part on determinations regarding the content that should directed to the user, the content that is appropriate given the user's dynamically determined preferences and/or profile, how the content should be delivered, etc., can, at a time convenient to the user, establish a live audio-visual connection between a sales representative of the retail establishment and the user. The time at which it would be convenient to establish the live audio-visual connection between the sales representative and the user can be inferred (e.g., through use of inference engines and/or machine learning mechanisms) utilizing a predictive profile and/or the user's proximity to the retail establishment. During the live audio-visual connection the sales representative can provide to the user a brief sales pitch regarding goods and/or services that the user has elicited (or to which the dynamically evolving profile indicates) a preference, and further since the sales pitch is from a live person (e.g., a sales representative) negotiation between the user and the sales representative can take place.

In addition to the components illustrated with regard to systems 200 and 300 depicted in FIGS. 2-3 other instrumentalities and functionalities can be associated with mobile device 102 and/or retail establishment component 104. For instance, both mobile device 102 and/or retail establishment component 104 can make beneficial use of data fusion components that can be utilized to take advantage of information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by either mobile device 102, retail establishment component 104, or both, can include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

Additionally, mobile device 102 and/or retail establishment component 104 can, for example, employ a synthesis aspect to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Such a synthesis aspect through combining and filtering can provide a set of information that can be more informative, or accurate (e.g., with respect to an entity's communicative or informational goals) and information from just one or two modalities, for example. As discussed above data fusion aspects can also be employed to learn correlations between different data types, and the synthesis component aspect can employ such correlations in connection with combining, or filtering the input data.

Furthermore, mobile device 102 and/or retail establishment component 104 can determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof Thus ascertaining appropriate context can provide current or historical data in connection with inputs to increase proper interpretation of inputs. For example, time of day may be helpful to understanding an input—in the morning, the word “drink” would likely have a high a probability of being associated with coffee, tea, or juice as compared to being associated with a soft drink or alcoholic beverage during late hours. Context can also assist in interpreting uttered words that sound the same (e.g., steak and, and stake). Knowledge that it is near dinnertime of the user as compared to the user camping would greatly help in recognizing the following spoken words “I need a steak/stake”. Thus, based at least in part on knowledge that the user was not camping, and that it was near dinnertime, the utterance would be interpreted as “steak”. On the other hand, if the context aspect knew (e.g., via GPS system input) that the user recently arrived at a camping ground within a national park; it might more heavily weight the utterance as “stake”. In view of the foregoing, it is readily apparent that utilization of context to consider and analyze extrinsic information can substantially facilitate determining meaning of sets of inputs.

In addition, mobile device 102 and/or retail establishment component 104 can include presentation aspects that can provide various types of user interface to facilitate interaction between a user and any component coupled to mobile device 102 and/or retail establishment component 104. Such presentation aspects can be distinct from, but utilizable by, mobile device 102 and/or retail establishment component 104. The presentation aspects can provide one or more graphical user interface, command line interface, and the like. For example, a graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed.

Users can also interact with regions to select and provide information via various devices such as a mouse, roller ball, keypad, keyboard, and/or voice activation, for example. Typically, mechanisms such as a push button or the enter key on the keyboard can be employed subsequent to entering the information in order to initiate, for example, a query. However, it is to be appreciated that the claimed subject matter is not so limited. For example, merely highlighting a checkbox can initiate information conveyance. In another example, a command line interface can be employed. For example, the command line interface can prompt (e.g., via text message on a display and/or an audio tone) the user for information via a text message. The user can then provide suitable information, such as alphanumeric input corresponding to an option provided in the interface prompt or an answer (e.g., verbal utterance) to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

Additionally, as has been elucidated above, mobile device 102 and/or retail establishment component 104 can utilize artificial intelligence to facilitate its ends. Accordingly, mobile device 102 and/or retail establishment component 104 can employ a probabilistic based or statistical based approach, for example, in connection with making determinations or inferences. Inferences can be based in part upon explicit training of classifiers (not shown) and/or implicit training based at least in part upon system feedback and/or users previous actions, commands, instructions, and the like during use of the system. The artificial intelligence aspects can employ any suitable scheme (e.g., neural networks, expert systems, Bayesian belief networks, support vector machines (SVMs), Hidden Markov Models (HMMs), fuzzy logic, data fusion, etc.) in accordance with implementing various automated aspects described herein. Further, the artificial intelligence aspects can factor historical data, extrinsic data, context, data content, state of the user, and can compute cost of making an incorrect determination or inference versus benefit of making a correct determination or inference. Accordingly, a utility-based analysis can be employed with providing such information to other components or taking automated action. Ranking and confidence measures can also be calculated and employed in connection with such analysis.

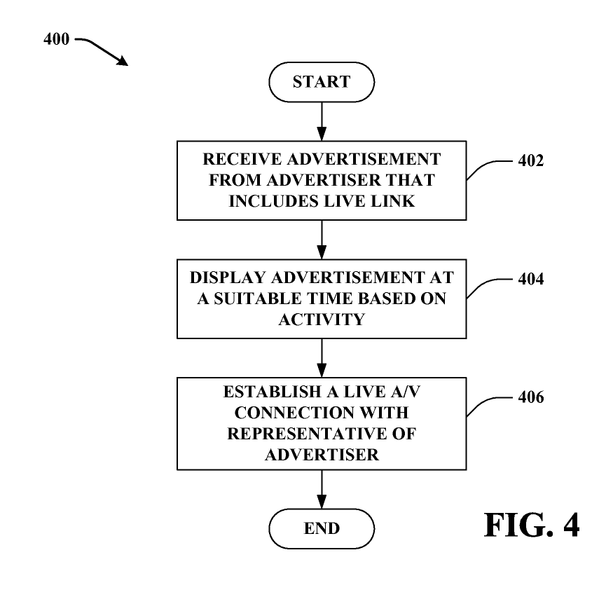

In view of the illustrative systems shown and described supra, methodologies that may be implemented in accordance with the disclosed subject matter will be better appreciated with reference to the flow charts of FIGS. 4-6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 4 depicts a method 400 that effectuates and/or facilitates advertising as a real-time video call in accordance with an aspect of the claimed subject matter. Method 400 can commence at 402 where a device (e.g., typically a mobile device) can receive an advertisement propagated and distributed by a point of sale or retail establishment. Generally, the advertisement disseminated by the point of sale or retail establishment can include, for example, a link to further advertising content wherein such content can be personalized to a user's specific tastes and dislikes. At 404 the advertisement dispatched from the advertising host or server (e.g., retail establishment component 104) can be displayed at a time that is convenient to the user. The time at which the advertisement is displayed can be determined based at least in part on collaborative filtering techniques, for instance. At 406 the user through interaction with his/her mobile device (e.g., through an appropriate interface generated by the mobile device and based at least in part on the advertisement to be displayed) can establish a live audio and/or visual (or text messaging) connection with a representative of the advertiser (e.g., with a product endorser such as Massimo Muscles or Traci Svelte, who is compelling to the user).

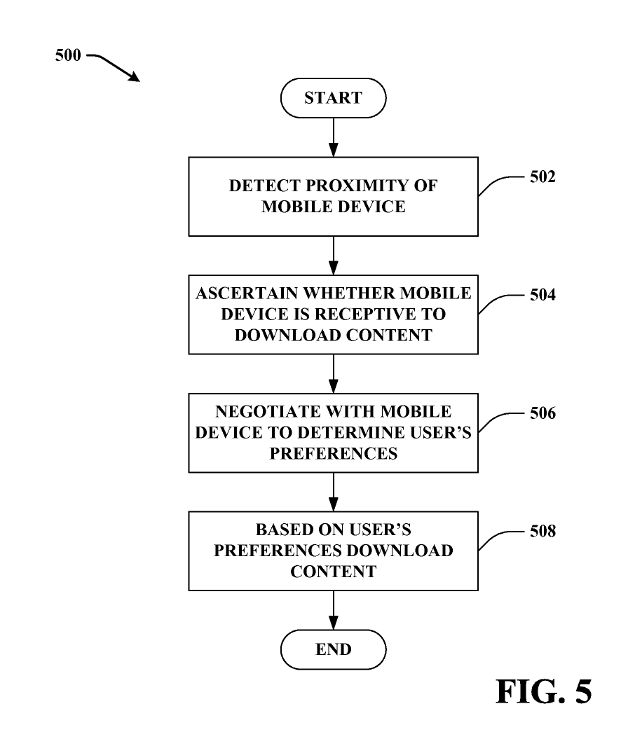

FIG. 5 provides exemplification of a methodology 500 that facilitates and/or effectuates advertising as a real-time call in accordance with an aspect of the claimed subject matter. Methodology 500 can commence at 502 where a point of sale or retail establishment component (e.g., retail establishment component 104) can detect whether or not a mobile device is within its proximity. At 504 the point of sale or retail establishment component can ascertain whether or not the detected mobile is receptive to the download or dissemination of advertising content. At 506 where it is determined that the detected mobile device within the vicinity of the retail establishment or point of sale is receptive to the download or dispatch of advertising content, negotiations between the detected mobile device and retail establishment or point of sale can be carried out to determine the user's preferences (as well as the capabilities of the device) with regard to the advertising content that should be sent to the mobile device. At 508 based at least in part on the user's preferences (as well as the capabilities of the user's device) the retail establishment or point of sale component can download or dispatch appropriate content on to the user's device. The content so disseminated can be viewed by the user immediately on dispatch or can be viewed by the user at a time of the user's choosing.

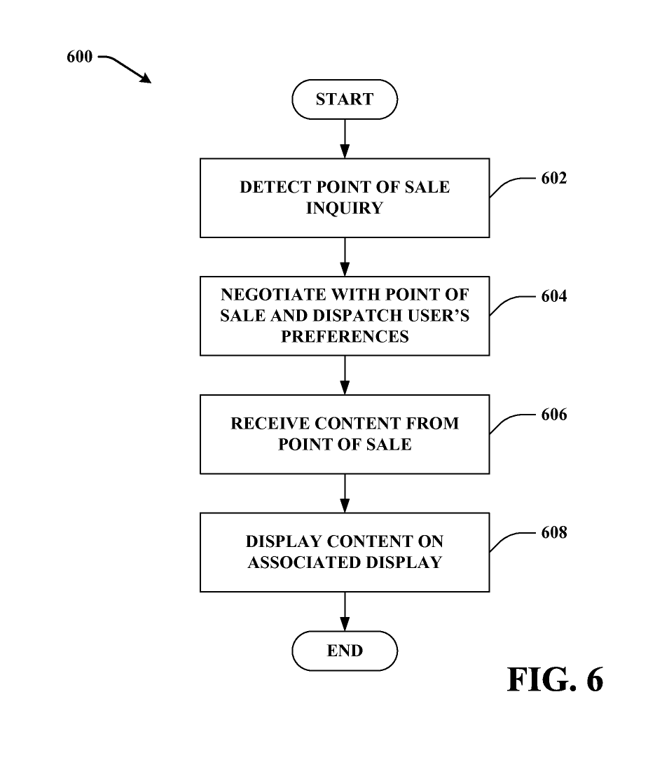

FIG. 6 illustrates a method 600 that facilitates and/or actuates advertising as a real-time video call in accordance with an aspect of the claimed subject matter. Method 600 can begin at 602 where a device detects that a point of sale or retail establishment is attempting to solicit a response from the device. Where the device is willing (or more particularly, where the user of the device wishes to receive) advertising content from the point of sale or retail establishment, negotiations between the device and the retail establishment or point of sale can take place at 604 wherein a copy of user's current preference profile that can have been persisted on the device can be dispatched to the requesting retail establishment or point of sale. At 606 in response and as a result to the various and sundry negotiations between the retail establishment or point of sale and the device, customized and/or individualized advertising content can be received. At 608 the received content can be displayed on the device (or more particularly on a display device associated with the device) either contemporaneously upon receipt or at a time of the user's choosing.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

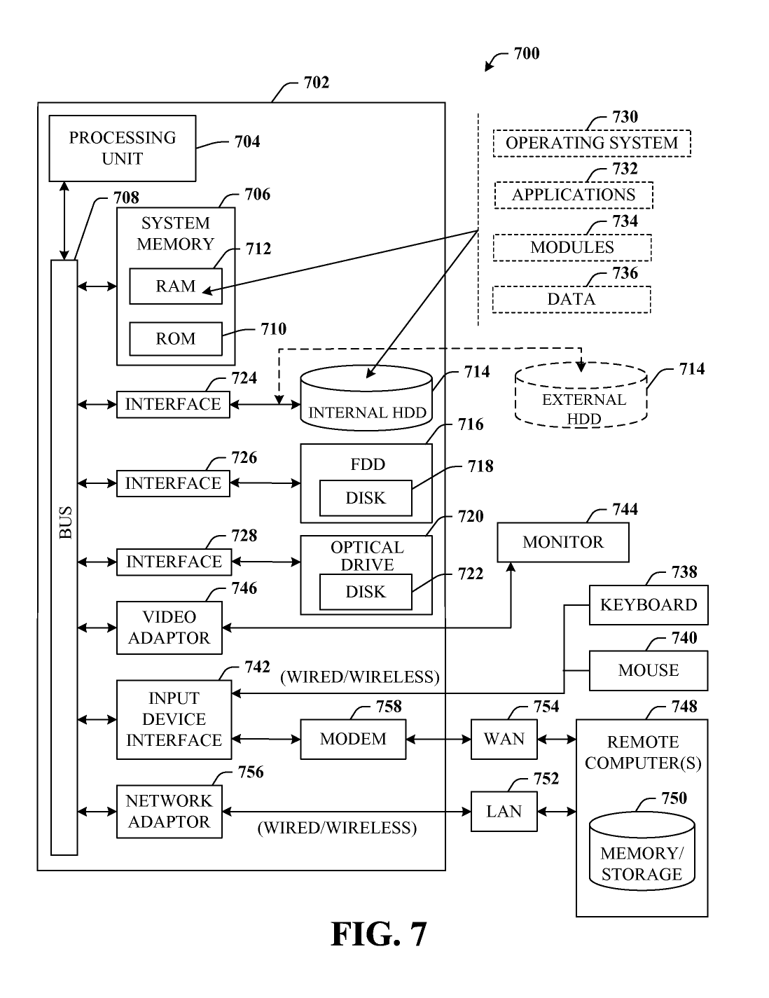

Referring now to FIG. 7, there is illustrated a block diagram of a computer operable to execute the disclosed system. In order to provide additional context for various aspects thereof, FIG. 7 and the following discussion are intended to provide a brief, general description of a suitable computing environment 700 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 7, the illustrative environment 700 for implementing various aspects includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 712, including an operating system 730, one or more application programs 732, other program modules 734 and program data 736. All or portions of the operating system, applications, modules, and/or data can also be cached in the RAM 712. It is to be appreciated that the claimed subject matter can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1094 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adaptor 756 may facilitate wired or wireless communication to the LAN 752, which may also include a wireless access point disposed thereon for communicating with the wireless adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are illustrative and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10 BaseT wired Ethernet networks used in many offices.

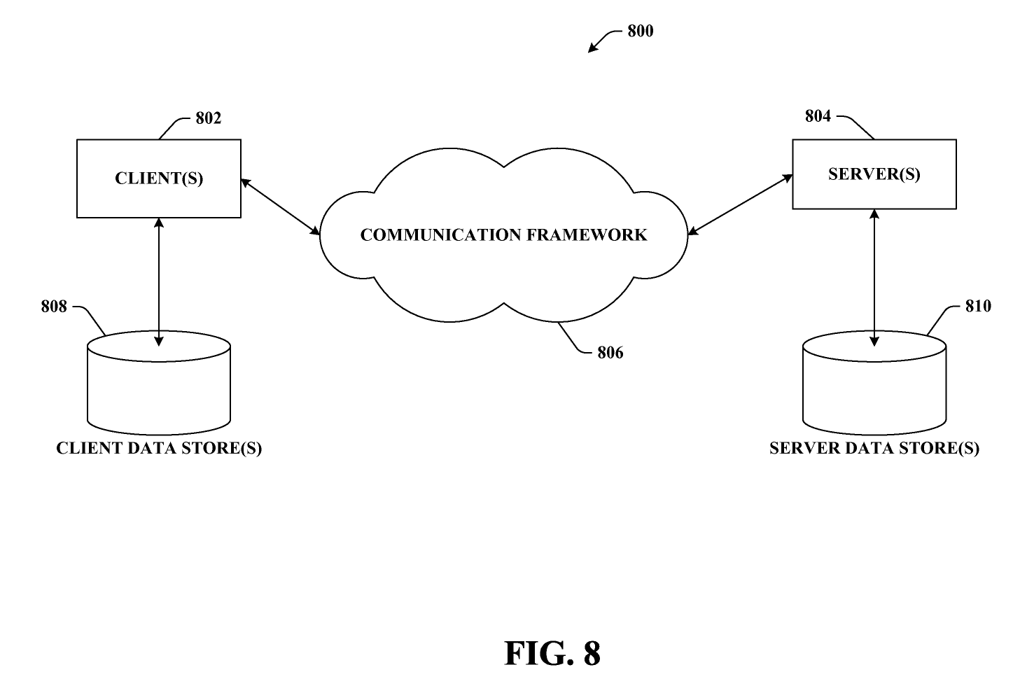

Referring now to FIG. 8, there is illustrated a schematic block diagram of an illustrative computing environment 800 for processing the disclosed architecture in accordance with another aspect. The system 800 includes one or more client(s) 802. The client(s) 802 can be hardware and/or software (e.g., threads, processes, computing devices). The client(s) 802 can house cookie(s) and/or associated contextual information by employing the claimed subject matter, for example.

The system 800 also includes one or more server(s) 804. The server(s) 804 can also be hardware and/or software (e.g., threads, processes, computing devices). The servers 804 can house threads to perform transformations by employing the claimed subject matter, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A machine implemented system that facilitates or actuates advertising as a real-time video call, comprising:
a processor configured to detect whether a mobile device associated with a user is in proximity of the processor, ascertain whether the mobile device is receptive to receipt of advertising as a real-time video call, negotiate with the mobile device to determine at least one user preference with respect to the real-time video call, and based at least in part on the at least one user preference, at least one of download the real-time video call to the mobile device or establish a live audio-visual connection with a representative of an advertiser, wherein during the live audio-visual connection negotiations between the user and the representative is effectuated and the user comprehends that the representative is a famous personality; and
a memory coupled to the processor for persisting data.

2. The system of claim 1, the real-time video call customized based at least in part on the at least one user preference.

3. The system of claim 1, the real-time video call provides a call-back telephone number that the user utilizes to download the advertizing associated with the real-time video call.

4. The system of claim 1, the negotiations with the mobile device further comprising utilization of one or more lists specific to the user to ascertain the at least one user preference with respect to the real-time video call.

5. The system of claim 4, the one or more lists developed utilizing collaborative filtering mechanisms.

6. The system of claim 1, the advertising associated with the real-time video call customized to ensure a first person narrative between the user and a personality indicated by the at least one user preference.

7. The system of claim 1, the negotiations with the mobile device further comprising utilizing one or more search term obtained from a search engine associated with the mobile device to ascertain the at least one user preference with respect to the real-time video call.

8. A machine-readable medium having stored thereon machine-executable instructions for:
detecting whether a mobile device associated with a user is in proximity of a retail establishment;
ascertaining whether the mobile device is receptive to receipt of advertising as a real-time video call from the retail establishment;
negotiating with the mobile device to determine at least one user preference with respect to the real-time video call;
based at least in part on the at least one user preference, establishing the real-time video call with a sales representative of the retail establishment wherein the sales representative adopts the mien of a famous personality; and
effectuating negotiations between the sales representative and the user during the real-time video call.

9. The machine-readable medium of claim 8, the real-time video call customized based at least in part on the at least one user preference.

10. The machine-readable medium of claim 8, the real-time video call provides a call-back number that the user utilizes to download advertizing associated with the real-time video call.

11. The machine-readable medium of claim 8, the negotiating further comprising utilizing one or more lists specific to the user to ascertain the at least one user preference with respect to the real-time video call.

12. The machine-readable medium of claim 11, the one or more lists developed utilizing collaborative filtering mechanisms.

13. The machine-readable medium of claim 8, the advertising associated with the real-time video call customized to ensure a first person narrative between the user and a personality indicated by the at least one user preference.

14. The machine-readable medium of claim 8, the negotiating further comprising utilizing one or more search term obtained from a search engine associated with the mobile device to ascertain the at least one user preference with respect to the real-time video call.

15. A system that actuates advertising as a real-time video call, comprising:
a memory that retains instructions for detecting whether a mobile device associated with a user is proximate to a point of sale, determining whether the mobile device is receptive to receipt of advertising as a real-time video call, negotiating with the mobile device to determine at least one user preference with respect to the real-time video call, and based at least in part on the at least one user preference, establishing the real-time video call between the user and a representative of the point of sale to provide a live sales pitch by the representative to the user, the live sales pitch delivered through voice synthesis to emulate a famous personality; and
a processor, coupled to the memory, that executes the instructions retained in the memory.

16. The system of claim 15, the real-time video call customized based at least in part on the at least one user preference.

17. The system of claim 15, the real-time video call provides a call-back number that the user utilizes to download advertizing associated with the real-time video call.

18. The system of claim 17, the call-back number dispatched to the mobile device included in a text-message.

19. The system of claim 15, the memory further retains instructions for utilizing one or more lists specific to the user to ascertain the at least one user preference with respect to the real-time video call.

20. The system of claim 15, the advertising associated with the real-time video call customized to ensure a first person narrative between the user and a personality indicated by the at least one user preference.
